(19) United States
(12) Patent Application Publication
(10) Pub. No.: US 2012/0259785 A1
(43) Pub. Date: Oct. 11, 2012

(54) AUTOMATED CUSTOMER RELATIONSHIP MANAGEMENT SYSTEM AND METHOD

(76) Inventor: Vincent Kwang Yuen Ha, Singapore (SG)

(21) Appl. No.: 13/082,462

(22) Filed: Apr. 8, 2011

(51) Int. Cl. G06Q 10/00

(52) U.S. Cl. 705/304

(57) ABSTRACT

The present invention generally relates to online social networking. Specifically, this invention relates to a system and method for providing a content evaluation and social networking platform that allows users to interact through the use of various roles, develop reputations through a personal and peer based rating system and exchange goods and services through use of an online currency that may be traded and exchanged in various real world currencies.

### FIELD OF THE INVENTION

The present invention generally relates to customer relationship management systems. Specifically, this invention relates to a system and method for providing an automated or semi-automated customer relationship management (CRM) module that provides one or more automated resolution processes over one or more networks.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

There are several CRM systems currently in use today that allow business users to interact and communicate with customers in order to handle one or more points of the customer relationship management process. Most of these systems, if not all, require a dissatisfied customer to contact the CRM system in order to start a complaint resolution process. Additionally, all of these systems require a customer to be fully identified prior to starting a complaint resolution process.

Additionally, current CRM systems do not have the capability to identify and analyze the effectiveness of particular dispute resolution processes in relation to other similarly situated processes. Furthermore, no CRM system has the capability to monitor the satisfaction of a customer with a particular resolution, even though the customer may have accepted one or more automated dispute resolution offer.

Additionally, none of the current CRM systems have the ability to search and analyze third-party content systems for complaints or other customer dissatisfactions and address these complaints or other customer dissatisfactions automatically. Many consumers post their disapproval of a company's products or services on blogs, websites, forums or other mediums where a company may never become aware of the complaints. This leaves negative reviews out in the wild where other potential customers can read them and decide not to pursue business with the company due to these reviews.

Finally, there are currently no CRM systems that provide businesses or individuals the capability of attaching to the complaints of customers or potential customers of competitors for the purpose of utilizing the customer's or potential customer's dissatisfaction with the competitor.

Therefore, there is a need in the art for a system and method for providing an automated customer relationship management module that is capable of tracking, analyzing and resolving consumer complaints with little or no manual interaction except as required to initially configure or optimally tune certain modules.

These and other features and advantages of the present invention will be explained and will become obvious to one skilled in the art through the summary of the invention, drawings, brief description of the drawings and detailed description that follows.

### SUMMARY OF THE INVENTION

Accordingly, the present invention provides an automated customer relationship management system capable of overcoming the shortcomings of previous CRM platforms. The CRM platform of the present invention provides systems and methods for automating customer complaint identification, initiating contact with a customer and automating the dispute resolution process.

According to embodiments of the present invention, a system and method for searching networks for complaints is provided. The system and methods herein described overcome the challenge of having complaints out in the wild which might negatively impact the reputation of one or more companies or individuals.

According to embodiments of the present invention, a system and method for competitive searching of networks for complaints is provided. The system and methods herein described overcome the challenge of analyzing and identifying the success and satisfaction rating of individual or groups of automated CRM components as it relates to customer complaint satisfaction.

According to embodiments of the present invention, the competitive searching systems and methods allow for a business user to automate or take manual control over the adoption of new CRM components and the retirement of poorly operating CRM components.

According to embodiments of the present invention, a system and method for providing automated resolution of complaints raised by entire groups of customers or potential customers. The system and methods herein described overcome the challenge of having to resolve complaints on the individual level.

According to embodiments of the present invention, a system and method for providing anonymous resolution of complaints. The system and methods herein described overcome the challenge of having to fully identify one or more customers or potential customers prior to resolving their complaints.

According to embodiments of the present invention, a system and method for providing a social aspect to resolution of customer complaints. The system and methods herein described overcome the challenge of having to provide resolution to customer complaints in a non-social, individual manner. In this embodiment, a social aspect may be achieved, even where the individual parties are anonymous.

According to embodiments of the present invention, a system and method for providing a “gamification” process for the resolution of complaints. The system and methods herein described overcome the challenge of having the resolution of complaints process be boring and stressful.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 is a schematic overview of a network system for carrying out this invention in accordance with an embodiment of the present invention;

FIG. 2 is an exemplary embodiment of a graphical user interface which shows the identification of individuals with similar names and individuals with the same name in different locations;

FIG. 3 is an exemplary embodiment of a graphical user interface which shows a term suggestion component suggesting replacement words based on user entered content;

FIG. 4, is a decision tree configuration for an automated dispute resolution method in accordance with an embodiment of the present invention;

FIG. 5 is a schematic overview of a CRM module in accordance with an embodiment of the present invention;

FIG. 6 is a flowchart describing an exemplary automated search and dispute identification method, in accordance with an embodiment of the present invention;

FIG. 7 is a flowchart describing an exemplary automated dispute resolution method, in accordance with an embodiment of the present invention;

FIG. 8 is an exemplary CRM module as it would appear to a customer or potential customer, in accordance with an embodiment of the present invention;

FIG. 9 is an exemplary CRM module as it would appear to a customer or potential customer, in accordance with an embodiment of the present invention;

FIG. 10 is an exemplary CRM module as it would appear to a customer or potential customer, in accordance with an embodiment of the present invention;

FIG. 11 is an exemplary CRM module as it would appear to a customer or potential customer, in accordance with an embodiment of the present invention;

FIG. 12 is an exemplary CRM module as it would appear to a customer or potential customer, in accordance with an embodiment of the present invention;

FIG. 13 is an exemplary CRM module as it would appear to a customer or potential customer, in accordance with an embodiment of the present invention;

FIG. 14 is an exemplary CRM module as it would appear to a customer or potential customer, in accordance with an embodiment of the present invention;

FIG. 15 is an exemplary CRM module as it would appear to a customer or potential customer, in accordance with an embodiment of the present invention;

FIG. 16 is an exemplary CRM module as it would appear to a customer or potential customer, in accordance with an embodiment of the present invention;

FIG. 17 is an exemplary CRM module as it would appear to a customer or potential customer, in accordance with an embodiment of the present invention.

FIG. 18 is an exemplary CRM module as it would appear to a customer or potential customer, in accordance with an embodiment of the present invention.

FIG. 19 is an exemplary gamification system presented via a CRM module, in accordance with an embodiment of the present invention;

FIG. 20 is an exemplary gamification system presented via a CRM module, in accordance with an embodiment of the present invention;

FIG. 21 is an exemplary CRM module as it would appear to a business or individual, in accordance with an embodiment of the present invention;

FIG. 22 is an exemplary CRM module as it would appear to a business or individual, in accordance with an embodiment of the present invention; and

FIG. 23 is an exemplary dashboard for a CRM module as it would appear to a business or individual, in accordance with an embodiment of the present invention.

### DETAILED SPECIFICATION

The present invention generally relates to customer relationship management systems. Specifically, this invention relates to a system and method for providing an automated or semi-automated customer relationship management (CRM) module that provides one or more automated resolution processes over one or more networks.

According to an embodiment of the present invention, the system and method is accomplished through the use of one or more computing devices. One of ordinary skill in the art would appreciate that a computing device appropriate for use with embodiments of the present application may generally be comprised of one or more of a Central processing Unit (CPU), Random Access Memory (RAM), and a storage medium (e.g., hard disk drive, solid state drive, flash memory). Examples of computing devices usable with embodiments of the present invention include, but are not limited to, personal computers, smart phones, laptops, mobile computing devices, and servers. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

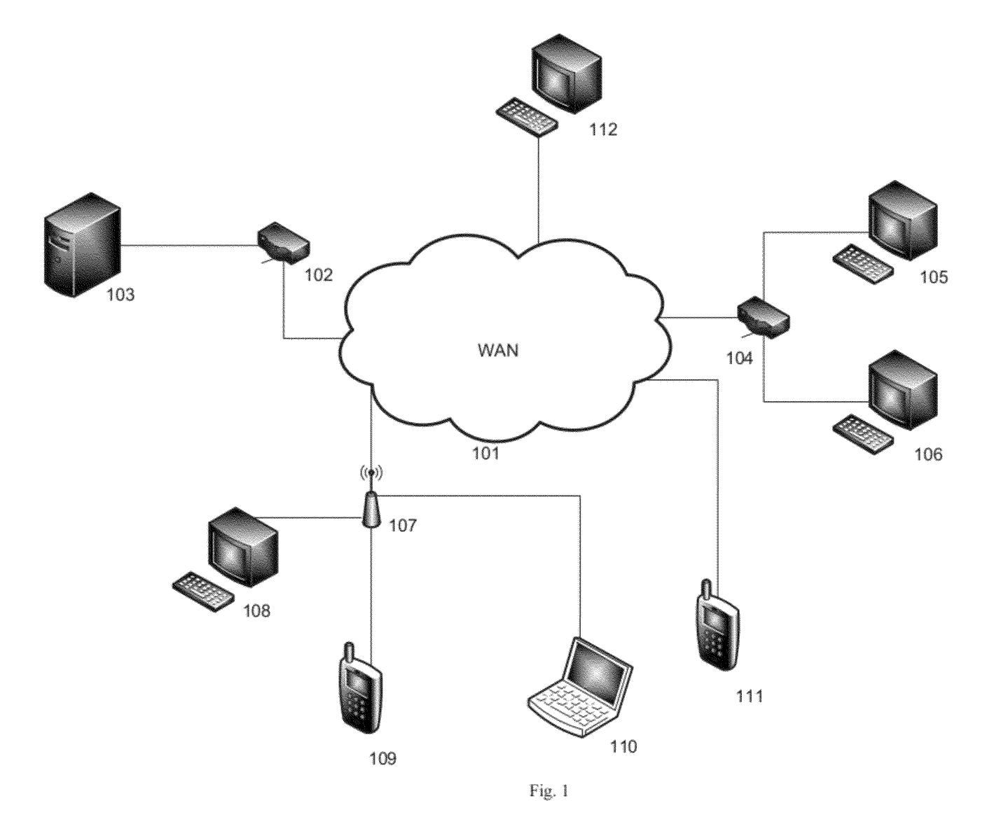

Referring to FIG. 1, a schematic overview of a system in accordance with an embodiment of the present invention is shown. The system is comprised of one or more application servers 103 for electronically storing information used by the system. Applications in the server 103 may retrieve and manipulate information in storage devices and exchange information through a WAN 101 (e.g., the Internet). Applications in server 103 may also be used to manipulate information stored remotely and process and analyze data stored remotely across a WAN 101 (e.g., the Internet).

According to an exemplary embodiment, as shown in FIG. 1, exchange of information through the WAN 101 or other network may occur through one or more high speed connections directed through one or more routers 102. Router(s) 102 are completely optional and other embodiments in accordance with the present invention may or may not utilize one or more routers 102. One of ordinary skill in the art would appreciate that there are numerous ways server 103 may connect to WAN 101 for the exchange of information, and embodiments of the present invention are contemplated for use with any method for connecting to networks for the purpose of exchanging information.

Members may connect to server 103 via WAN 101 or other network in numerous ways. For instance, a Member may connect to the system i) through a computing device 112 directly connected to the WAN 101, ii) through a computing device 105, 106 connected to the WAN 101 through a routing device 104, iii) through a computing device 108, 109, 110 connected to a wireless access point 107 or iv) through a computing device 111 via a wireless connection (e.g., CDMA, GMS, 3G, 4G) to the WAN 101. One of ordinary skill in the art would appreciate that there are numerous ways that a member may connect to Server 103 via WAN 101 or other network, and embodiments of the present invention are contemplated for use with any method for connecting to Server 103 via WAN 101 or other network.

CRM Features

According to an embodiment of the present invention, the systems and methods herein described are accomplished through the use of one or more automated or semi-automated CRM modules. These CRM modules may be configured to scan local and remote content for data related to a business or individual. In particular, a CRM module will scan for negative comments or other content related to the business or individual.

Scanning of content may be accomplished in numerous manners. For instance, keywords and/or key-phrases may be used to search for text based content for comments related to the business or individual. In other embodiments, image recognition or multimedia content recognition algorithms may be utilized to scan for multimedia content related to the business individual. For instance, image recognition techniques could be used to find uses of a logo or image related to the business or individual in conjunction with negative textual content. One of ordinary skill in the art would appreciate that there are numerous methods for scanning text and other forms of content, and embodiments of the present invention are contemplated for use with any method of scanning any form of content.

According to an embodiment of the present invention, keywords, key-phrases or other content related to a business or individual may be selected by the particular business or individual in order to maximize the efficiency and accurateness of their search. By selecting relevant content identifiers, search results returned will be more accurate and only provide results distinctly relevant to the particular business or individual.

According to an embodiment of the present invention, local and remote content to be scanned may include, but is not limited to, microblogging streams, webpages, forums, social network feeds, RSS feeds and other publicly available information sources. One of ordinary skill in the art would appreciate that there are numerous types of content that may be scanned, and embodiments of the present invention are contemplated to scan any type of content.

According to an embodiment of the present invention, one or more CRM modules may be configured in such a manner as to be competitive with one another. In this manner, each CRM module may be configured with different keywords or other content identifiers, and with different resolution processes, described later in this application. The performance of each CRM module may be monitored and analyzed, individually, in conjunction with other CRM modules or any combination thereof. Criteria for analyzing CRM modules includes, but is not limited to, number of search results returned, accuracy of search results, customer satisfaction with dispute resolution options and methods and quality of resolutions in comparison with other CRM modules. One of ordinary skill in the art would appreciate that there are numerous criteria that could be utilized in the analysis of CRM modules, and embodiments of the present invention are contemplated for use with any criteria.

According to an embodiment of the present invention, criteria for ranking a CRM module may include, but is not limited to:

1) how many times a complaint is shared by customers;

2) how many interactions (e.g., comments, posts, messages, links) a complaint has received;

3) how popular an entity being complained about is (e.g., number of mentions over a time period);

4) how long ago the complaint was created;

5) is the compliant related to a group (i.e., a number of customers with a similar complaint);

6) if yes to #5, how many members in the group;

7) the number of competitors of an entity;

8) is the customer related to the complaint seeking dispute resolution (e.g., explicitly/implicitly indicated in the complaint);

9) the number of complaints from a particular customer regarding the entity;

10) has a resolution already taken place for the particular complaint;

11) how many keywords or key-phrases are identified; and

12) how many times has a keyword or key-phrase been searched.

The aforementioned criteria may be used individually or in conjunction with one another to properly identify and rank identified complaints. The aforementioned list is not exhaustive, and one of ordinary skill in the art would appreciate that there are numerous other criteria that could be utilized with embodiments of the present invention, and embodiments of the present invention are contemplated for use with any criteria.

An example of a ranking of a CRM module, in accordance with an embodiment of the present invention, follows. The CRM module may be ranked with the following criteria, as weighted (e.g., Wtl-Wtn) by the business or individual configuring the CRM module: 1) percentage of times customers accepted one or more dispute resolutions suggested by the CRM module (C %); 2) percentage of times dispute resolution occurred prior to requiring human interaction (R %); and 3) the average ranking given to the dispute resolutions by customers (Rank %). Total score could be calculated via a function, such as:

Total Score: [Rank %]*(Wt1)+[R%]*(Wt2)+[C%]*(Wt3)

The result of this calculation could be used to determine an overall effectiveness of a CRM module, particularly in relation to other CRM modules managed by a business or individual. The aforementioned calculation is merely an example and one of ordinary skill in the art would appreciate that any number of calculations may be made to determine the effectiveness of a CRM module or group of CRM modules based on ranking and weighting various criteria.

According to an embodiment of the present invention, the CRM module may be configured to identify one or more types of tags associated with a complaint in order to allow for more efficient searching or to make sure their complaint is properly identified. For instance, a customer may use an “@” symbol or “#” symbol to identify the business or individual associated with a complaint or the type of goods/services related to the complaint. In this manner, CRM modules can be configured to identify and rank accordingly complaints with appropriate tags. One of ordinary skill in the art would appreciate that there are numerous tags that could be utilized to identify various aspects of a complaint, and embodiments of the present invention are contemplated for use with any tag type.

According to an embodiment of the present invention, the systems and methods herein described may be configured in such a manner that poorly performing CRM modules may be automatically taken offline. For instance, if a user sets up a plurality of CRM modules and over the course of time, a subset of that plurality is performing exceptionally well in comparison to the other CRM modules, the poorly performing CRM modules may be automatically deprecated and removed. The user could set certain criteria for allowing the system to automatically deprecate a CRM module. For instance, a user could set a CRM module to cease operation if customer satisfaction with resolutions stemming from that CRM module are below a certain level or if the CRM module fails to return a certain number of search results within a given time period.

One of the main aspects of the CRM module is to automate the dispute resolution process between a company or individual and a consumer or other third-party. In this manner, once the CRM module has successfully identified a potential complaint against the company or individual the CRM module represents, the CRM module may initiate an automated complaint resolution process with the third-party posting the complaint. One key advantage to this method is that the CRM module may begin its complaint resolution methodology even where the customer or potential customer is anonymous, such as in the case of a customer or potential customer who made a microblogging post related to the business or individual. The CRM module may be configured to provide identifiers to anonymous users, such as a unique ID, one that is separate from a user's ID.

Automated Group Dispute Resolution

According to an embodiment of the present invention, groups may be identified through the systems and methods herein described as well. Groups may be comprised of anonymous customers, anonymous potential customers, identifiable customers, identifiable potential customers or any combination thereof. In this manner, the CRM module may be configured to handle multiple complaints at one time, providing a evenly distributed response or complaint resolution. Advantageously, customers receive similar results based on similar complaints and an overall satisfaction with a resolution may be determined and later modified if it is determined that the overall satisfaction is below some threshold.

According to an embodiment of the present invention, a group or thread of customers with complaints may be provided certain management features over the group. For instance, a group may be provided the ability to select a representative or leader of the group. This group leader may be provided with the authority to conduct the dispute resolution process on behalf of the entire group. In this manner, once the leader settles on a specified dispute resolution settlement, each of the participants in the group will automatically receive and be required to accept the specified dispute resolution settlement. Alternatively, this may follow similar procedures as those commonly seen in class action lawsuits, where a class of individuals is provided with the option to accept the settlement or opt out and attempt to negotiate their own settlement or resolution.

According to an embodiment of the present invention, a leader of a group or thread may be chosen by a majority vote of a group. In this manner, a democratic approach may be utilized to select a leader of a group or thread. Voting may occur more than once, for instance if a group or thread grows, a later vote may be made to either confirm or replace the leader based on the opinions of the group. One of ordinary skill in the art would appreciate that there are numerous methods for selecting a leader of a group or a thread, and embodiments of the present invention are contemplated for use with any method for selecting a leader of a group or thread.

According to an embodiment of the present invention, a group leader may be able to manage the content and nature of the group, including which customers or potential customers are assigned to the group. One of ordinary skill in the art would appreciate that there are numerous privileges that could be granted to the leader of a group or thread, and embodiments of the present invention are contemplated for use with providing any privilege or set of privileges to a group or thread leader.

According to an embodiment of the present invention, a group or thread of customers with complaints may be approached or presented with resolutions from the competitors of a business or individual associated with the original complaint. In this manner, competitors may attempt to attract the business of groups of consumers that have identified themselves as unhappy or dissatisfied with the products or services of a particular business or individual.

According to an embodiment of the present invention, a group or thread of customers with complaints may be provided numerous dispute resolution offers, provided by one or more businesses or individuals. In this manner, a group or thread may act as a repository where customers with complaints can go to vent their complaints and CRM modules may present dispute resolution offers to those customers as a whole. This has the advantage of automatically informing and updating groups of customers all at the same time and presenting an even dispute resolution process to all customers similarly situated.

CRM Configuration

According to an embodiment of the present invention, the CRM module may be comprised of an automated dispute resolution process module that is pre-configured by a business or individual. In one embodiment, the business or individual may pre-configure an automated dispute resolution process module to handle the numerous manners. For instance, the automated dispute resolution process module may be configured to make initial contact with a customer or potential customer who has been identified by search methods of the CRM module. In this manner, the business or individual may create a series of initial contact routines that have been determined to appropriately open the lines of communication with the identified customer or potential customer. In one example, an automated dispute resolution process module may send an electronic communication (e.g., e-mail, sms message, forum post, response to a microblogging post, automated voice-call) to the identified customer or potential customer. Said electronic communication may be comprised of a standard greeting, such as, “Hi there, my name is ______ and I noticed that you are having a problem with [Business Name]'s [Product/Service]. I would love the opportunity to assist you with your problem.”

According to an embodiment of the present invention, CRM modules may be configured by a business or individual to identify complaints related to their competitors. In this manner, a CRM module can approach customers of a competitor and offer to provide dispute resolution services aimed at poaching the customer or potential customer of the competitor. In an exemplary embodiment, there may also be one or more identifiers associated with a complaint that assist businesses or individuals in identifying complaints related to the products or services of a competitor. Identifiers may include, but are not limited to, tags, keywords, key-phrases and product SKUs.

For an example of the previous method, a customer could post a complaint related to services received from Company X. Company X is identified by the tag “#CompanyX.” In the complaint posted by the customer, the customer includes the “#CompanyX” tag. The customer also indicates that Company X has failed to resolve his complaint via a separate identifier (e.g., a tag titled “#Unresolved”). Company Y may have a CRM module configured to identify complaints involving the “#CompanyX” tag, especially those also identified as unresolved. When a complaint involving Company X is identified by the CRM module of Company Y, the CRM module may initiate contact with the customer, offering them a deal or other incentive package in order to persuade the customer to switch their services to those of Company Y.

According to an embodiment of the present invention, if the customer or potential customer accepts the initial contact with the business or individual, a series of pre-configured steps may continue. Each step may presented based on one or more responses received from the customer or potential customer. Much like a decision tree, each earlier decision may provide a distinct pathway through the resolution process. At the end, the goal is to 1) resolve the customer's or potential customer's complaint, 2) have the views and opinions the customer or potential customer has of the business or individual improved and/or 3) reward the customer or potential customer for participating in the process (e.g., provide discounts, coupons, access to services or support).

According to an embodiment of the present invention, the following is an example of how the configuration of a CRM module may occur. In a first step, a business or individual may create a new CRM module, give it a unique or non-unique identifier (e.g., name), one or more tracked names (e.g., company name, product name, service name, keywords), one or more classifications (e.g., “telecommunications”, “computer hardware”, “computer software”, “utilities”, “consumer goods”, “consumer services”), the names or other identifiers of one or more competitors, location (e.g., city, state, country) and CRM module administrators.

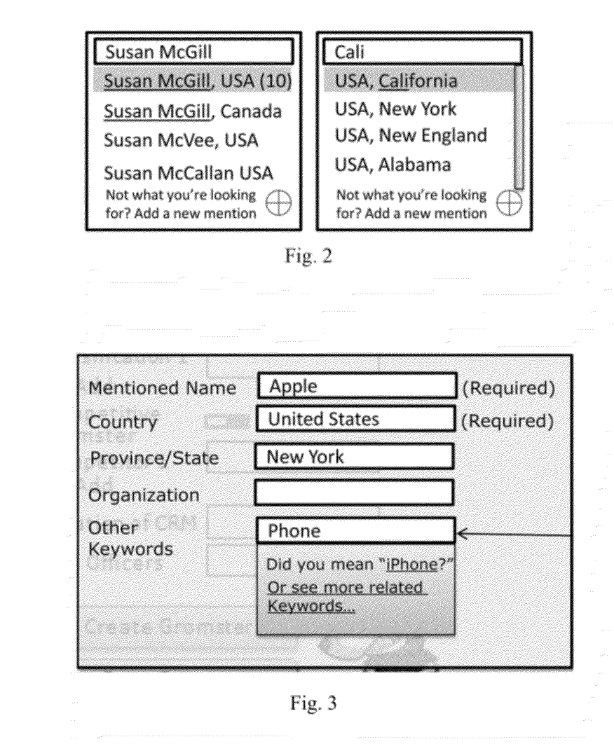

According to an embodiment of the present invention, tracked names may be used to help identify businesses or individuals with names that sound the same or with multiple locations. An example of this can be seen in FIG. 2, which shows the identification of individuals with similar names and individuals with the same name in different locations. Advantageously, the system and methods herein described can help businesses and individuals identify complaints, even where the customer or potential customer has misspelled or misidentified the location of the business or individual.

According to an embodiment of the present invention, the CRM module configuration system may also suggest to the business or individual certain similar keywords. An example of this can be seen in FIG. 3, which shows a term suggestion component suggesting replacement words based on user entered content. Advantageously, the system and methods herein described can help businesses and individuals select appropriate terms to be used with their CRM module.

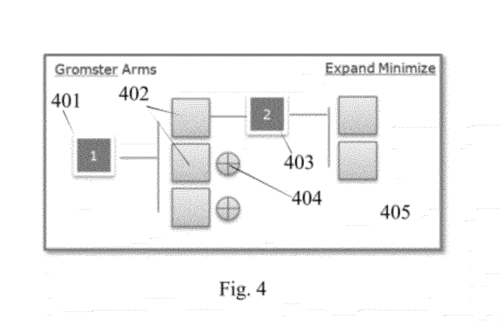

According to an embodiment of the present invention, after the initial settings are configured, the business or individual may then configure the automated dispute resolution methods of the CRM module. An example of this can be seen in FIG. 4, which shows a decision tree configuration for an automated dispute resolution method in accordance with the present invention. In this embodiment, A graphical user interface (GUI) may be provided to the user to assist with the configuration along various routes of questioning. As shown, an initial question 401 represents the first question that may be presented to a customer or potential customer. The initial response 402 to the initial question 401 may be multiple choice, free form, or any other format for receiving responses. The business or individual may configure the options for the initial response 402 based on a variety of criteria (e.g., expected response to initial question 401). One or more second level questions 403 may be configured based upon what initial response 402 was received/selected. During the configuration process, the GUI may allow for one or more second level questions 403 to be opened. Alternatively, the questions at this level may be shown as one or more collapsed questions 404. Collapsed questions 404 help provide a cleaner and more desirable user experience while interacting with the system and methods herein described. FIG. 4 goes on to show the one or more second level responses 405. This process of question and response may continue for as many levels as necessary to gather enough information to resolve a customer or potential customer's complaint.

According to an embodiment of the present invention, at any level of questioning, after receiving a response, the CRM module may offer one or more dispute resolution offers to the customer or potential customer. For instance, if it has been determined through the questioning that the user is upset because they feel they paid too much for a particular good, the CRM module related to the business selling the particular good could be configured to offer a rebate check.

According to an embodiment of the present invention, the CRM module may be further configured to allow one or more users or managers to have certain privileges over the module. These privileges may include, but are not limited to, enabling the CRM module, disabling the CRM module, providing manual dispute resolution where necessary or identified, view reports related to the CRM module and assigning the CRM module to other users. One of ordinary skill in the art would appreciate that there are various privileges that may be utilized with CRM modules in accordance with embodiments of the present invention, and embodiments of the present invention are contemplated for use with any privilege or set of privileges.

According to an embodiment of the present invention, after the CRM module has been configured by the business or individual, a testing widget may be presented to the business or individual. This testing widget would allow a business or individual to see what the CRM module would look like in operation as presented to a customer or potential customer, and test out the performance of the CRM module, for instance, in a sandbox mode.

After Configuration

According to an embodiment of the present invention, the automated dispute resolution process module may be configured to adapt based on information gained from one or more sources. So while initial automated dispute resolution process modules may be designed to be pre-configured by a business or individual, as data in the system is built and accumulated over time, automated dispute resolution process modules may be automatically configured. Using historical data and analysis of said historical data allows automated dispute resolution process modules to be automatically configured based upon previous results using similar automated dispute resolution processes. For instance, if a particular set of question and response pathways have been determined to quick and efficiently resolve customer or potential customer complaints, at the same time keeping said customer or potential customer satisfied with the results, these question and response pathways may be automatically incorporated into the automated dispute resolution process modules of new CRM modules and placed into the wild. Advantageously, the ability of businesses and individuals to quickly and effectively enact new systems to resolve customer complaints is significantly improved, reducing the overall cost of customer complaints and images issues that may arise therefrom.

According to an embodiment of the present invention, while the systems and methods herein are most beneficial to a business or individual when the process can be executed in a fully automated manner, some situations will require a dispute resolution process to be transferred and handled manually. For instance, if no pre-configured dispute resolution methods solve the issues presented by a customer or potential customer, the automated dispute resolution process module may transfer the dispute to be handled by one or more customer support personnel.

Game Mechanics

According to an embodiment of the present invention, the system and methods herein provided may allow for direct customer interaction with the CRM module. The CRM module may provide a customer the ability to directly submit content to the business or individual related to the CRM module. Additionally, the CRM module may provide a gamification method of the dispute resolution process in order to alleviate stress related to the transaction and to lift the overall opinion the customer has of the business or individual related to the CRM module. Gamification methods include providing game mechanics to the standard CRM methodology. For instance, a customer may be provided a game where he is allowed to smash products, logos or other emblems of the business or individual. While these may appear on the outset to be overly negative actions, humor and self-deprecation tactics are frequently used to raise the spirits of a customer. It should be noted that any game mechanics may be utilized with the CRM module, including those that do not portray the business or individual in a negative light. One of ordinary skill in the art would appreciate that there are numerous game mechanics that could be used with embodiments of the present invention, and embodiments of the present invention are contemplated for use with any number of game mechanics.

According to an embodiment of the present invention, game mechanics and gamification methods may be incorporated at any time within the automated dispute resolution process. For instance, at any time the customer has to wait for the automated dispute resolution process module to make a decision, the customer may be presented with the opportunity to engage with the game mechanics of the CRM module.

Exemplary Embodiments

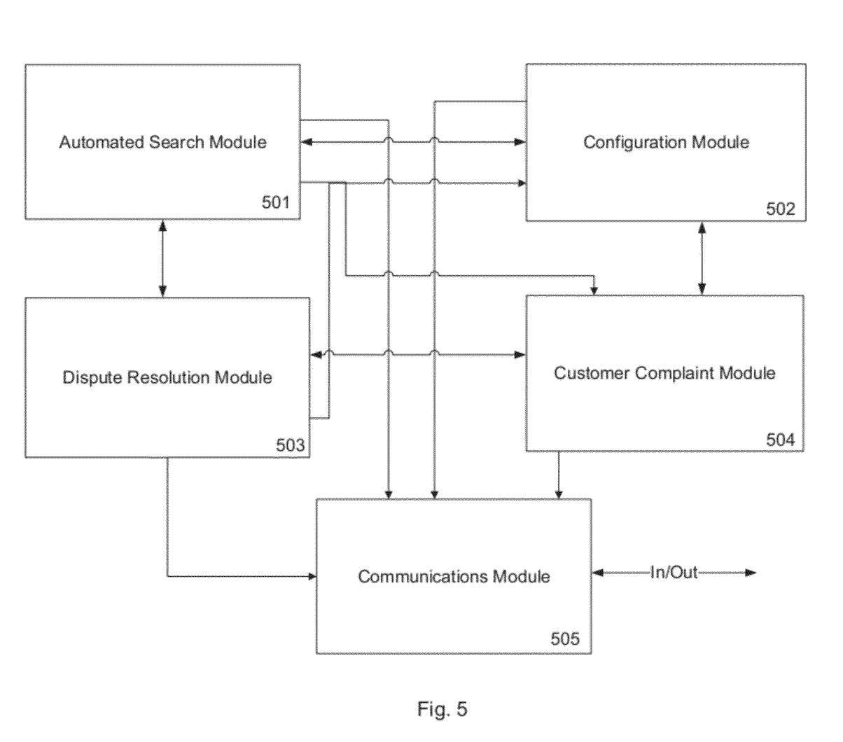

Turning now to FIG. 5, an exemplary embodiment of the present invention is shown. In this embodiment the systems and methods herein described are accomplished through the use of one or more of an automated search module 501, a configuration module 502, a dispute resolution module 503, a customer complaint module 504 and a communications module 505.

According to an embodiment of the present invention, automated search module 501 is configured to receive data for use in identifying comments, posts or other interactions regarding the products, services and/or other interests of a business or individual. The data, as previously described herein, may be comprised of one or more, keywords, key-phrases or other multimedia content that may be used to identify the products, services or other interests of a business or individual. In operation, the automated search module 501 utilizes the data, in conjunction with search algorithms, to identify a set of one or more interactions (e.g., microblogging posts, forum posts, web pages). Once one or more interactions have been identified, the automated search module 501 may pass the information related to the one or more interactions to a dispute resolution module 503 for further processing.

According to an embodiment of the present invention, a configuration module 502 is configured to allow a user to select parameters to be used by the other components of the system herein described. For instance, configuration module 502 may allow for a user to enter in keywords, key-phrases or other multimedia content that may be used to identify the products, services or other interests of a business or individual. Additionally, configuration module 502 may be configured to allow a user to setup one or more parameters related to automated dispute resolution policies in accordance with the desires of a particular business or individual. Configuration module 502 may also track one or more metrics related to one or more automated search modules 501 and/or dispute resolution modules 503. In this manner, the configuration module 502 may allow a user to track performance and modify parameters to provide better results.

According to an embodiment of the present invention, a dispute resolution module 503 is configured to receive data related to one or more interactions from one or more automated search modules 501. The dispute resolution module 503 may be comprised of elements that allow for the extraction of identifying information and contact information from an interaction. For instance, the dispute resolution module 503 may scan text or other content for the name, phone number, e-mail address and one or more usernames related to the customer or potential customer that created the interaction. The dispute resolution module 503 may utilize this information to initiate contact with a customer or potential customer. The dispute resolution module 503 may be further configured to identify the nature of an interaction, and make determinations based on the nature of the interaction. For instance, the dispute resolution module 503 may be capable of determining if an interaction is of a positive nature, and therefore not require any automated dispute resolution to take place.

According to an embodiment of the present invention, the dispute resolution module 503 may be configured to handle additional contacts with a customer or potential customer after the initial contact. For instance, the dispute resolution module 503 may be configured to continue one or more predetermined question and response series to identify and resolve a complaint of a customer or potential customer. Additionally, dispute resolution module 503 may utilize gamification methods in conjunction with the dispute resolution process.

According to an embodiment of the present invention, the dispute resolution module 503 may be configured to handle the dispute resolution process with multiple customers or potential customers at the same time. In this manner, groups of individuals may have their complaints settled at the same time, reducing the overall processing time of complaints. Additionally, gamification methods previously discussed may be included to allow the multiple customers or potential customers to interact and play games, chat or take part in other enjoyable activities while their complaints are being resolved.

According to an embodiment of the present invention, the customer complaint module 504 may be configured to allow customers or potential customers to contact the systems and methods herein described without waiting for the automated search module 501 to identify them. In this manner, a customer who has a complaint may initiate the automated dispute resolution process at their convenience.

According to an embodiment of the present invention, the communications module 505 is configured to allow the transfer and storage of data to and from the system. Transfer of data may be across one or more LANs or WANs or occur completely within a single computing device, such as the transfer of data to a storage medium or the committal of data to a database. The communications module 505 may be further configured to encrypt, decrypt, encode, decode or otherwise process the data for security or compliance purposes.

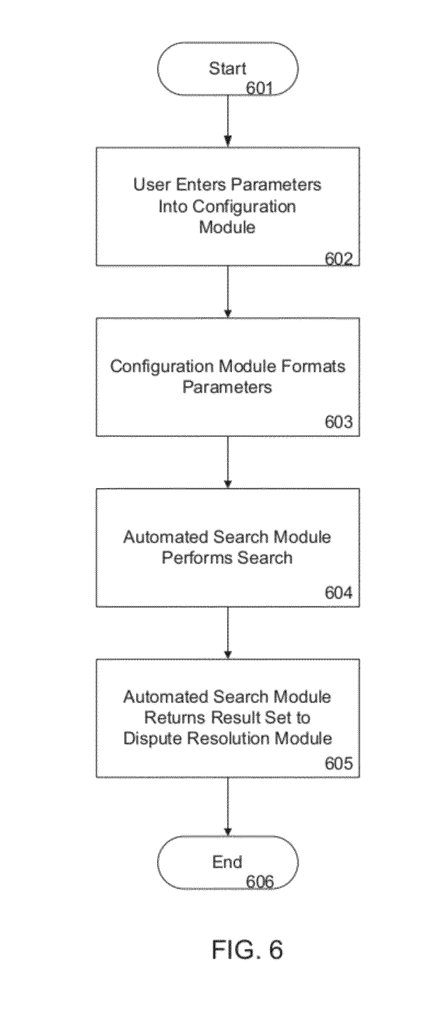

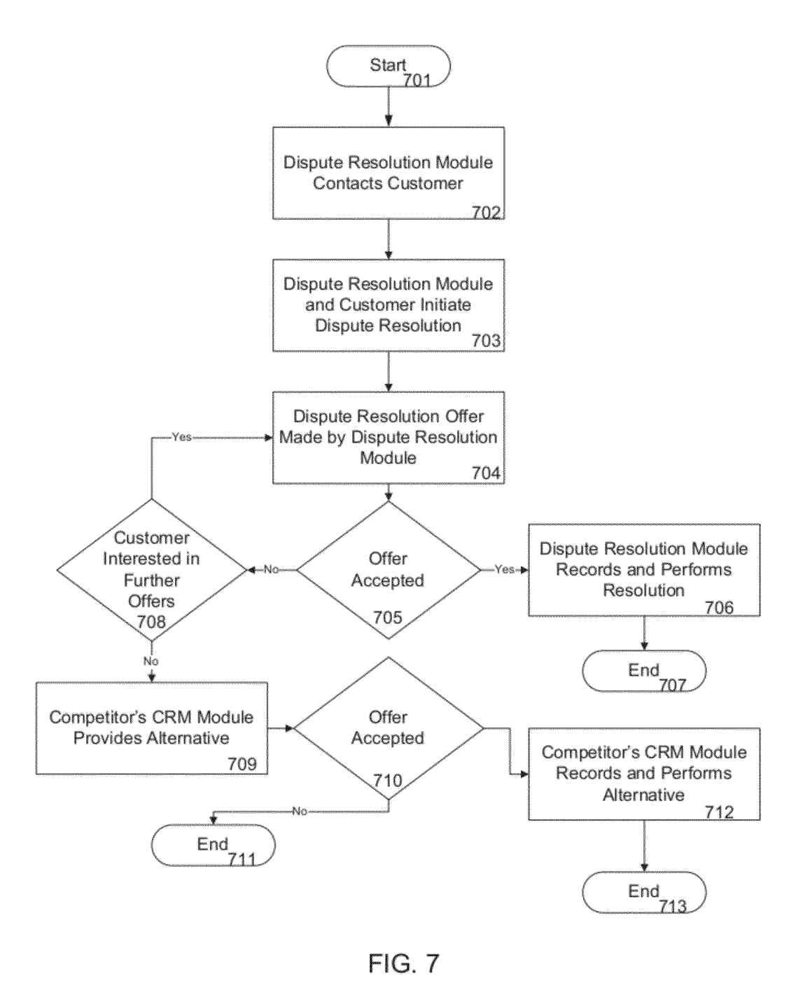

Turning now to FIG. 6, an automated search and dispute identification method, in accordance with an embodiment of the present invention, is shown. The process starts at step 601. At step 601, a user has engaged a configuration module 502 in order to configure a CRM module in accordance with an embodiment of the present invention.

At step 602, the user interacts with the configuration module 502 in order to enter one or more parameters that will be used by one or more automated search modules 501 to identify interactions related to a business or individual. The user at this point may also utilize any historical data from previously run searches in order to select parameters that have been successful in the past. The user may also configure the processes the dispute resolution module 503 may take in order to resolve and identified interactions.

Alternatively, the configuration can be automated by the user. In this manner, the user allows the configuration module 502 to make selections and decisions based on criteria that is defaulted in the system, configured previously by a user, analyzed from historical data or any combination thereof.

Once the user has completed his interaction with the configuration module 502, the user may launch the CRM module, progressing the system to step 603. At this step, the configuration module takes the identified parameters and converts the parameters into data points usable by the various modules throughout the system. The system may also be configured to adapt parameters identified by the user into additional data points that may provide a greater chance for success. For instance, a keyword may have both common permutations added by the system as well as phonetic misspellings, such that a customer or potential customer who has misspelled the keyword would still have their interaction identified by the system.

At this point, the configuration module 502 transfers the configured data points to the various modules of the CRM module that will be utilized. For instance, the configuration module 502 may transfer data points to the automated search module 501 and dispute resolution module 503. In some configurations, the configuration module 502 may be required to transfer data points to the communications module 505 to transfer the data points to CRM modules remote from the local configuration module 502.

At step 604, one or more automated search modules 604 perform a search for one or more interactions based on the parameters set by the user or selected by the system automatically. The search may be one that runs continuously, always searching for new results as they may appear. Alternatively, the search may occur over a selected time period (e.g., 2 hours, 2 weeks, 2 months), at certain identified times (e.g., 2 am Wednesday), based on certain criteria (e.g., CPU load <50%) or any combination thereof. These non-continuous search methods may be advantageous where system resources are a commodity and timing of searches helps to alleviate load at critical times.

At step 605, the system has identified one or more interactions that require dispute resolution. These results may be returned as they are identified or in a batch at certain intervals or at the end of a search period. The interactions are passed to one or more dispute resolution modules 503. Once received at the dispute resolution module 503, the interactions are screened for information (e.g., customer identity and contact information, interaction nature, need of dispute resolution, appropriate type of dispute resolution). Depending on the amount of information that is retrieved from the interaction, the dispute resolution module 503 may take one or more actions related to the interaction. These are described below in the discussion of FIG. 4.

At step 606, the process is complete. The previous steps are merely for example purposes. The steps are not required to be executed in this order, and one of ordinary skill in the art would appreciate that these steps could be executed in a variety of different manners as well as having two or more of the steps executing simultaneously.

Turning now to FIG. 4, an automated dispute resolution method, in accordance with an embodiment of the present invention, is shown. The process starts at step 701. At step 701, an automated search module 501 has identified one or more interactions and transfers the data related to the one or more interactions to one or more dispute resolution modules 503. Additionally, the dispute resolution modules 503 have identified certain relevant information related to the one or more interactions such that the dispute resolution process may begin. For instance, the dispute resolution module may have identified at least one or more methods for interacting with the customer or potential customer and identified that the interaction is one that may require dispute resolution.

At step 702, the dispute resolution module 503 makes one or more attempts to contact the customer or potential customer associated with an interaction requiring dispute resolution. The customer or potential customer may be invited to enter into the dispute resolution process with the dispute resolution module 503 on the basis of the interaction. A dispute resolution module 503 may have more than one routine to initiate contact with a customer or potential customer, selection of which routine to use may be based at least in part on the nature of the interaction. For instance, if an interaction is identified as openly hostile towards the business or individual, a routine with a reconciliatory tone could be selected.

At step 703, the customer has accepted the dispute resolution module's 503 invitation to begin a dialogue regarding the resolution of the customer's complaint. In the automated process, the dispute resolution module 503 will present one or more dialog choices based in part on the nature of the complaint, the product or service involved and the parameters associated with the dispute resolution module 503. The dialog becomes part of an exchange between the customer and the dispute resolution module 503. A well configured dispute resolution module 503 will present dialog choices that help get to the root of the customer's issue and improve the overall view the customer has of the business or individual.

At step 704, the dispute resolution module 503 and the customer have completed one or more lines of dialog and will have identified the issues related to the complaint and the nature and severity of the complaint as well as possibly received some recommendations from the customer on what form of remedy the customer would like to receive from the business or individual in relation to the complaint. At this point, the dispute resolution module 503 may present to the customer an offer aimed at resolving the complaint.

The offer may be comprised of any number of tangible and intangible items. Offers may be as simple as pointing a customer to a place where they can resolve their issue (e.g., technical support department) or providing the customer with a coupon, gift card or other monetary settlement. On the other hand, offers may be complex, with any number of remedies and types of presentations to the customer.

At step 705, the customer decides if he wishes to accept the offer made by the dispute resolution module 503.

If the customer accepts the offer made by the dispute resolution module 503, the process proceeds to step 706. The dispute resolution module 503 may be configured to enact the accepted settlement offer. For instance, the dispute resolution module 503 may forward the customer to a requested site, initiate a monetary settlement process (e.g., send a check to the customer), send the customer an electronic or physical coupon, initiate a return merchandise authorization (RMA) process or any combination thereof. One of ordinary skill in the art would appreciate that there are numerous settlement offers that may be utilized with embodiments of the present invention, and embodiments of the present invention are contemplated for use with any settlement offer type.

At step 707, the process would be complete.

If the customer decides to reject the offer, the dispute resolution process may continue to step 708. At this point, the customer may decide whether he or she would like to continue with the dialog process or the offer process in order to attempt to find a solution the customer will accept. Alternatively, the customer may choose to move to a manual dispute resolution process (e.g., be forwarded to customer support) or terminate the dispute resolution process altogether. If the customer decides to continue with the dialog process or offer process, the system may return to these steps and continue the previously described loop.

Alternatively, the customer can choose not to continue with the dialog process or the offer process with the system. At this point, a competitor's CRM module may intercede and offer to resolve the complaint(s) of the customer. Shown as step 709, the competitor's CRM module may be configured to provide a dispute resolution alternative to the customer.

At step 710, the customer has the opportunity to decide whether he or she would like to accept the competitor's offer. If the customer decides to reject the competitor's offer, the process ends at step 711.

If the customer decides to accept the competitor's offer, the process may continue to step 712, whereby the competitor's CRM module could provide automated dispute resolution services as previously described herein. At step 713 the process would be complete. The previous steps are merely for example purposes. The steps are not required to be executed in this order, and one of ordinary skill in the art would appreciate that these steps could be executed in a variety of different manners as well as having two or more of the steps executing simultaneously. Additionally, as noted previously, at any point in the process, the system may present a customer or potential customer with a game to play.

According to an embodiment of the present invention, while the previous example shows the automated dispute resolution process being conducted and offered via a single CRM module, in other embodiments, the customer may be provided with the choice of several alternative dispute resolution methods, offered by one or more CRM modules. Additionally, the CRM modules and automated dispute resolution methods may be ranked (e.g., via previous customers), allowing a customer to select a CRM module that has a high rating compared to their particular issue. Advantageously, the customer may be provided the choice of which CRM module he or she would most like to interact. Also, at any time a customer is dissatisfied with a particular automated dispute resolution process, he or she may choose to be directed to another CRM module which may be more relevant or acceptable to the customer.

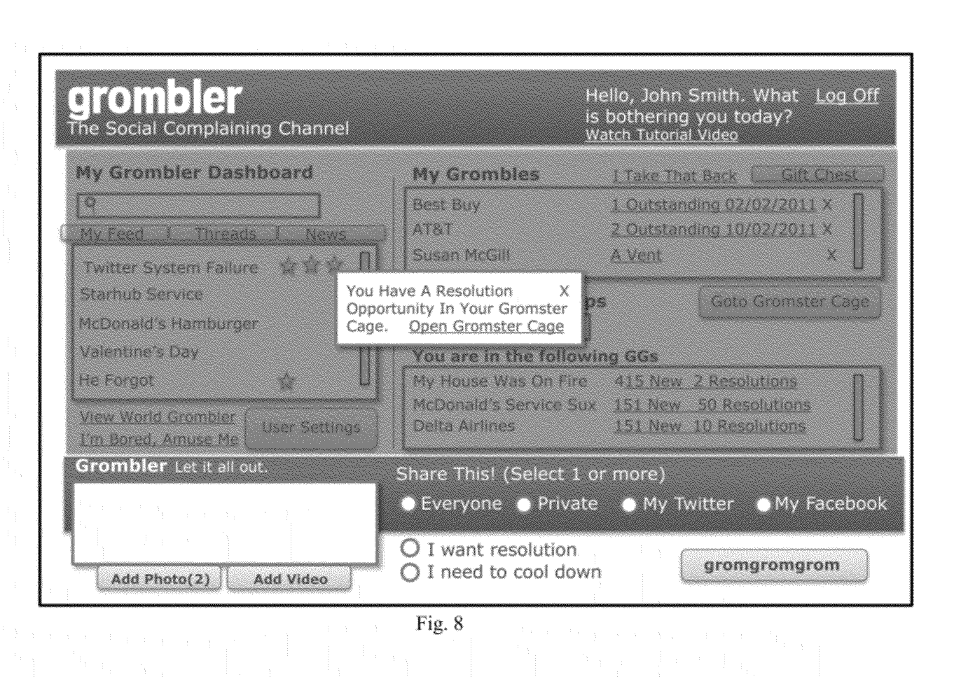

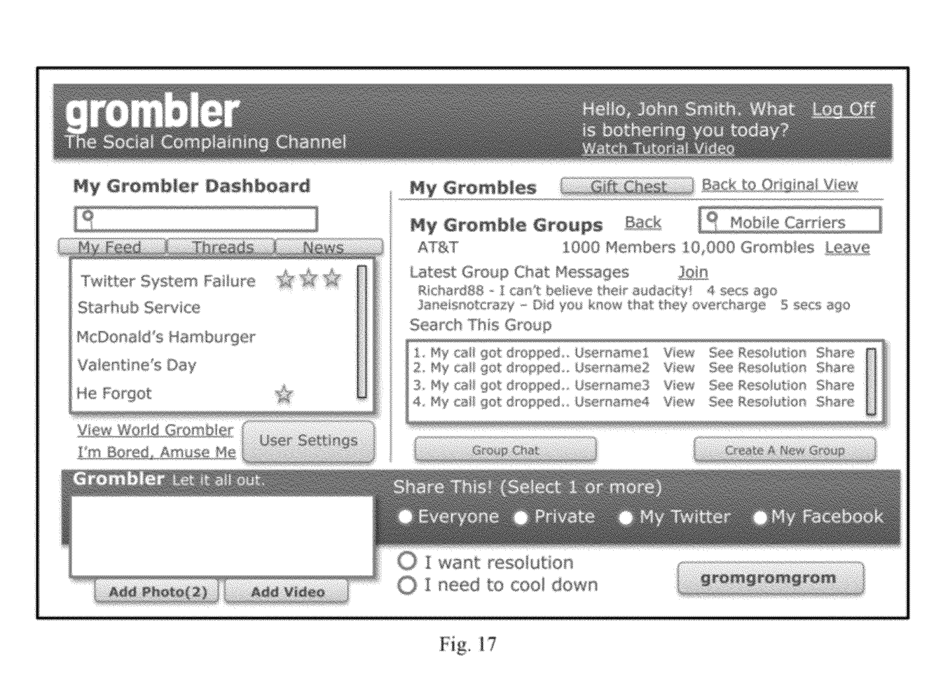

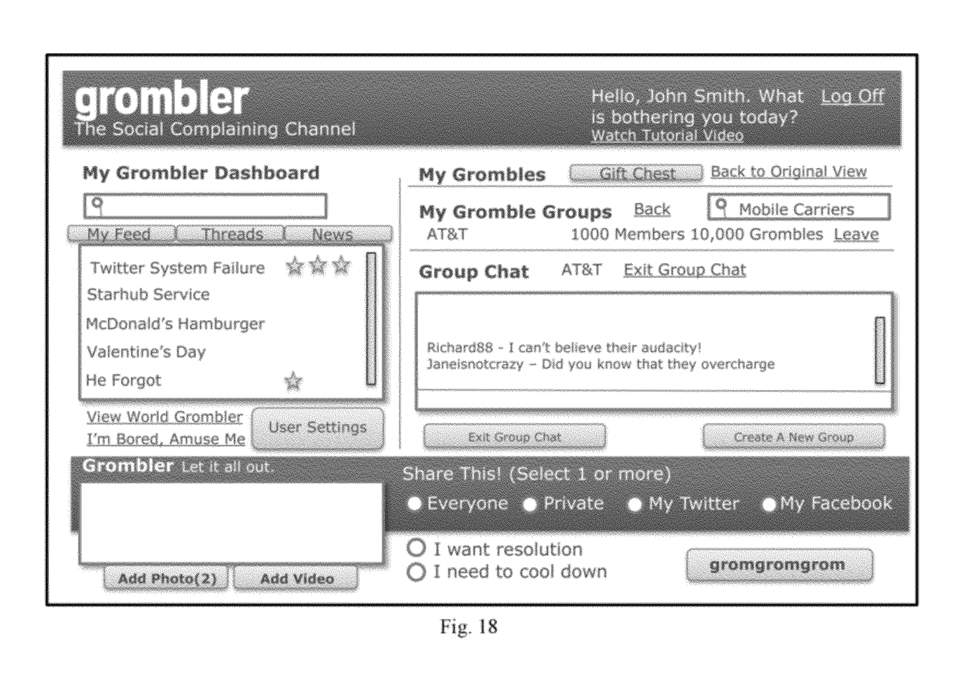

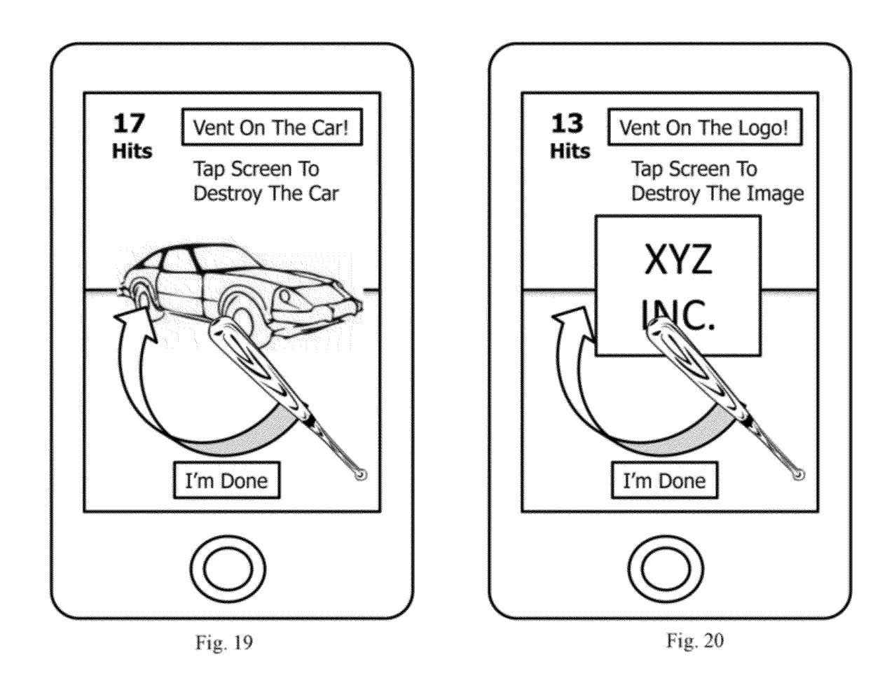

Turning now to FIGS. 8-20, an exemplary CRM module, as it would appear to a customer or potential customer, in accordance with an embodiment of the present invention, is shown. FIGS. 8-16 represent an example of a step by step flow through an automated dispute resolution process, in accordance with an embodiment of the present invention. FIGS. 17-18 represent an example usage in a group or threaded setting, with multiple customers in a single automated dispute resolution process. FIGS. 19-20 represent an example presentation of a gamification method intended to reduce the anger, frustration or other negative emotions a customer or potential customer may be experiencing.

Turning now to FIG. 8, one or more CRM modules initiate contact with a customer or potential customer. The customer is notified that one or more CRM modules wishes to initiate an automated dispute resolution process with the customer.

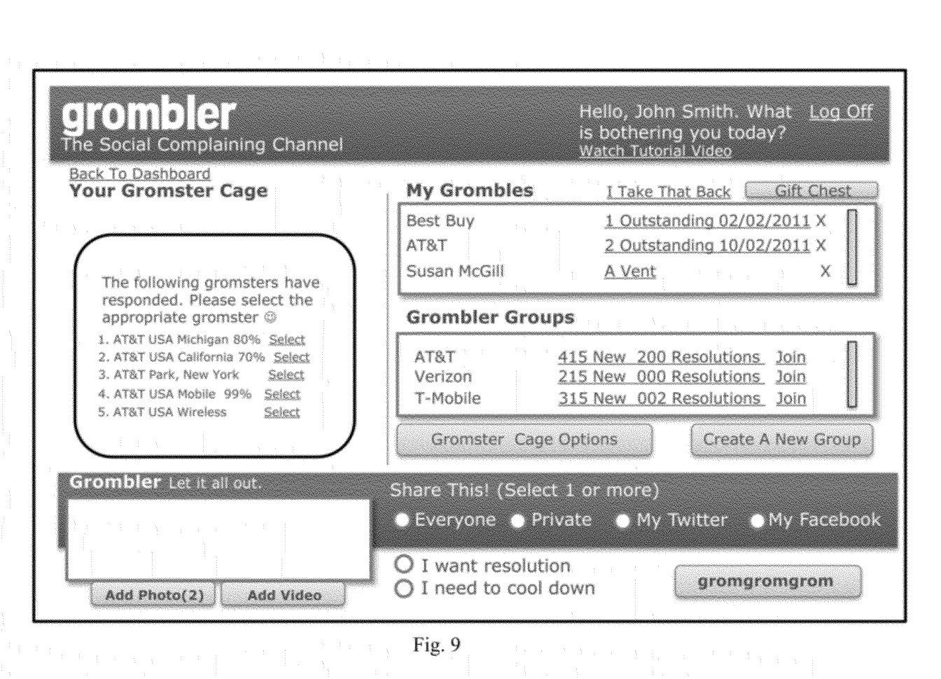

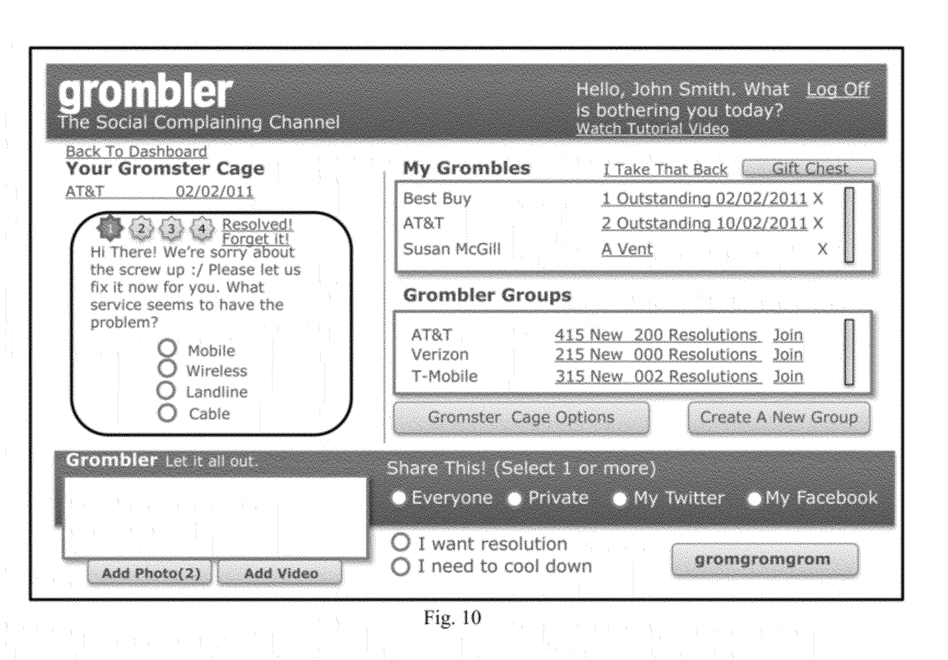

Turning now to FIG. 9, the customer is given a list of CRM modules that have requested to initiate contact with the customer. In this example, multiple CRM modules from the same company have identified the customer's complaint. According to an embodiment of the present invention, the customer may select the CRM module that most closely matches the business or individual the customer has a complaint with and would desire automated dispute resolution from.

Turning now to FIG. 10, continuing from the previous example, after the customer has selected the appropriate CRM module, the selected CRM module presents its initial response and first question to the customer. In this example, the CRM module wishes to identify the service the customer has a problem with.

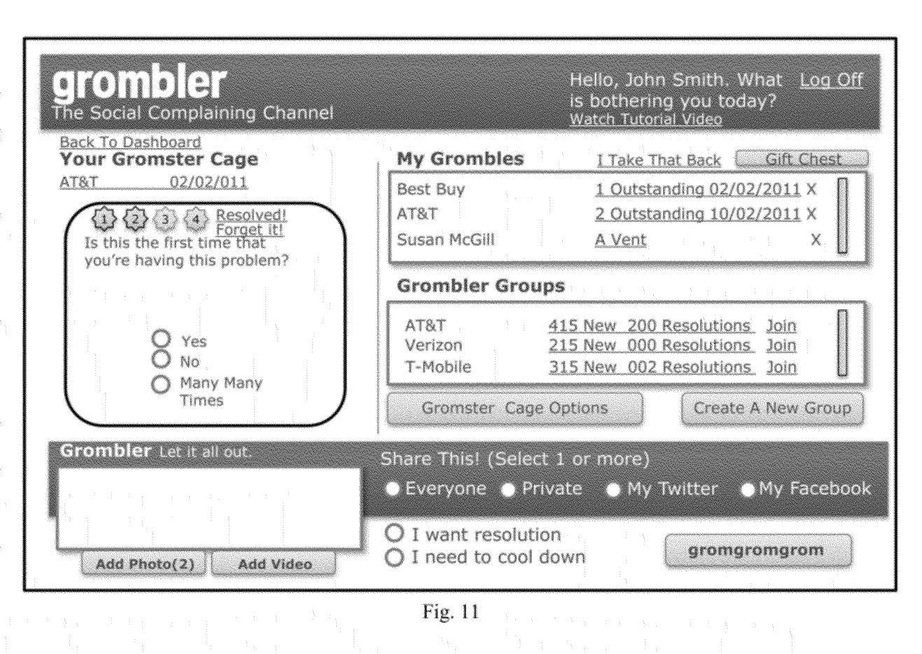

Turning now to FIG. 11, continuing from the previous example, after the customer has selected the type of service the customer has a problem with, the CRM module sends the second question in response to the customer's answer. In this example, the CRM module has been configured to ask the number of times the particular problem has arisen in the business's or individual's service provided to the customer.

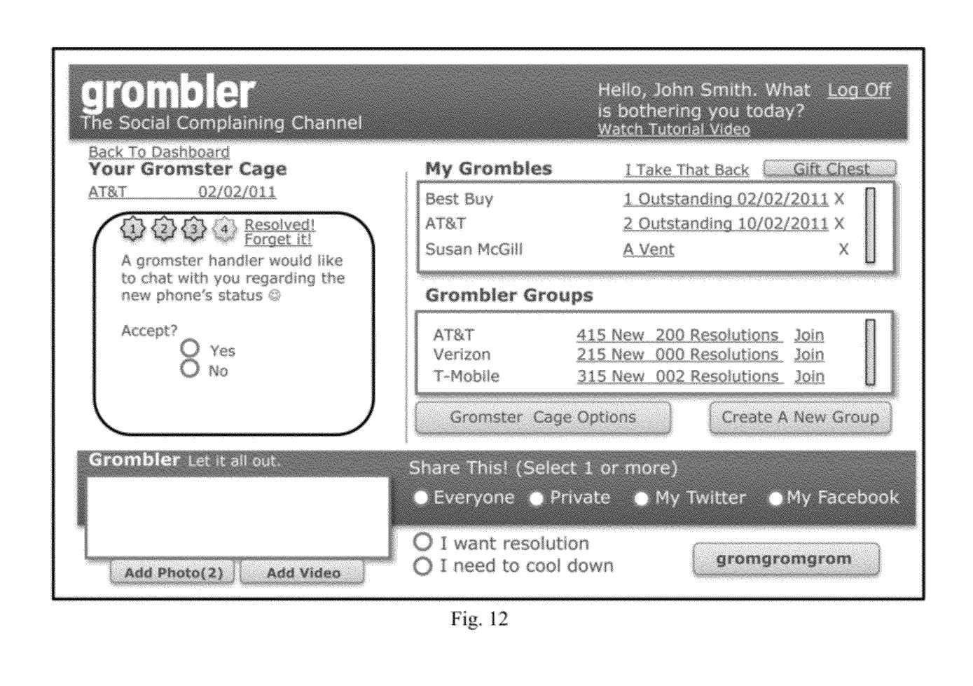

Turning now to FIG. 12, continuing from the previous example, after the customer has selected the number of times the particular problem has arisen in the business's or individual's service, the CRM module sends a third question in response to the customer's second answer. In this example, the CRM module has identified that human interaction is required to solve this complaint and asks the customer if they would be interested in speaking to a representative.

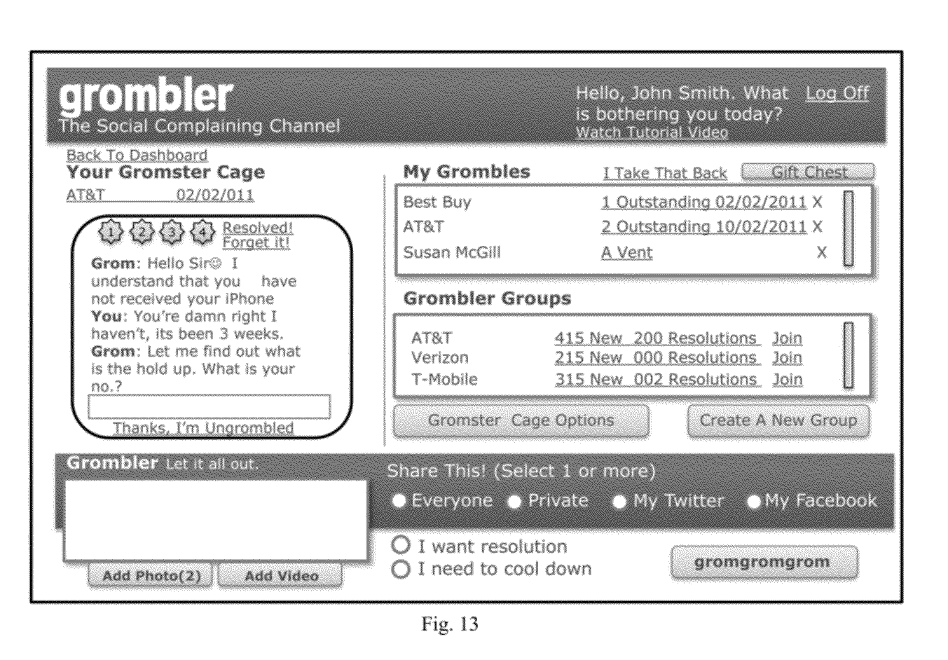

Turning now to FIG. 13, continuing from the previous example, after the customer has selected to speak to the representative, the customer and representative are able to discuss the complaint and how to resolve the issue. In this example, a customer is awaiting the delivery of a new product and the representative offers to help find out what the status of the shipment is.

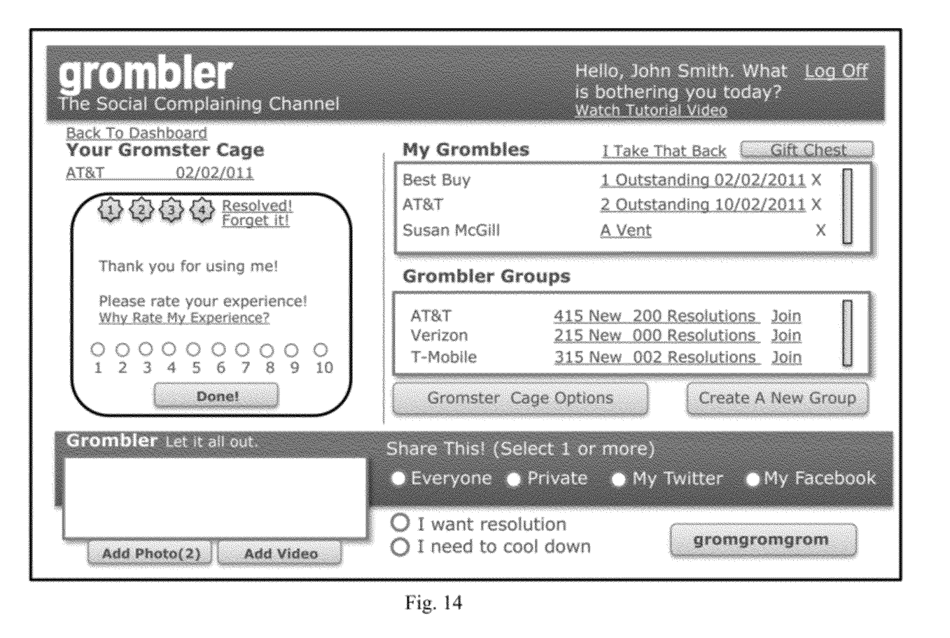

Turning now to FIG. 14, continuing from the previous example, after the customer has been served by the representative, the customer is given the opportunity to rate their experience with the CRM module. This information may be used later to identify the successfulness of both the CRM module and a particular representative associated with the dispute resolution process.

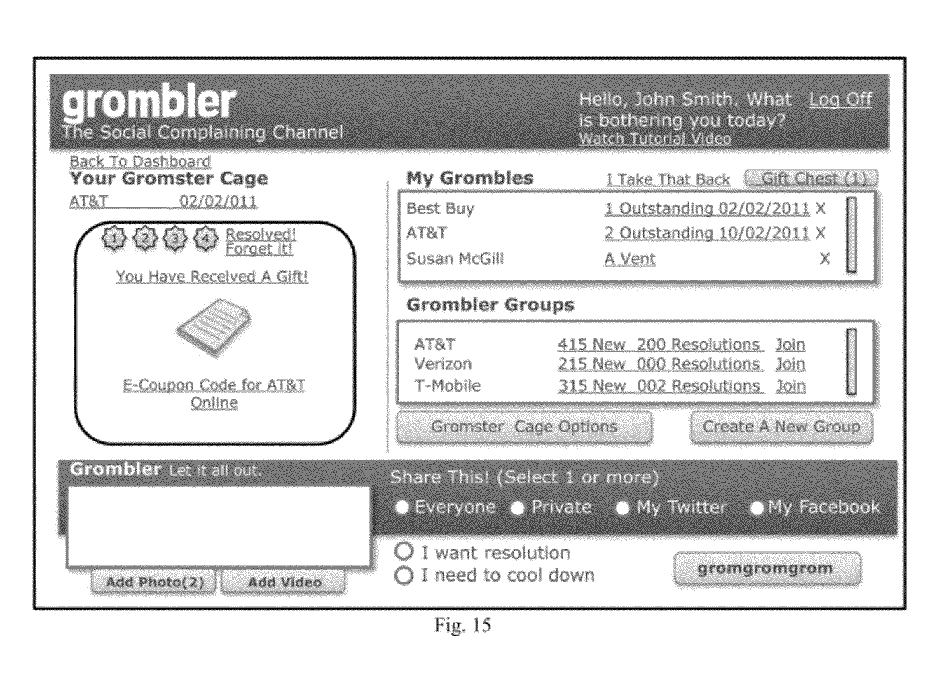

Turning now to FIG. 15, continuing from the previous example, after the customer has rated the CRM module, the customer is presented with the reward, settlement or other transaction completion related to the resolution of the customer's complaint through the dispute resolution process. In this example, the resolution includes a coupon code for a business's online store.

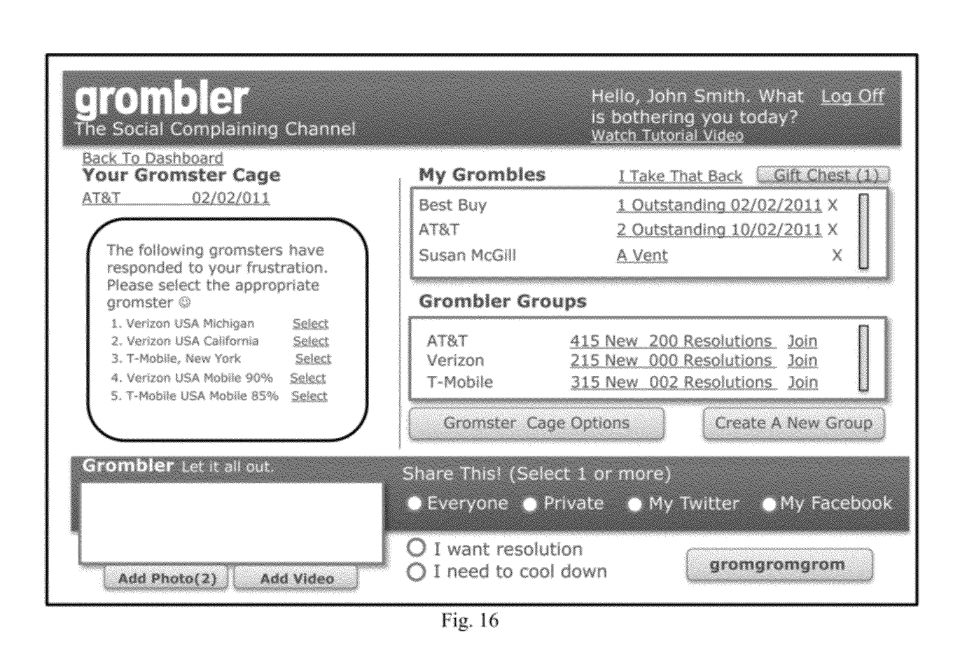

Turning now to FIG. 16, continuing from the previous example, after the customer has received their reward, settlement or other transaction completion related to the resolution of their complaint, the customer may be presented with one or more CRM modules of businesses or individuals that compete with the owner of the first CRM module. In this manner, competitive CRM modules may work to identify and steal the business of their competitors.

Turning now to FIG. 17, shows an exemplary CRM module, in accordance with an embodiment of the present invention, in a group or threaded context. In this embodiment, multiple users are able to voice their concerns, opinions or complaints in a combined area.

Turning now to FIG. 18, an exemplary CRM module, in accordance with an embodiment of the present invention, in a group or threaded context is shown. In this embodiment, two or more users are able to chat in the presented Group Chat window. Users may also be able to play games together or otherwise interact with one another.

Turning now to FIG. 19, a CRM module presents to a user, at the user's request, a game intended to allow the user to release negative feelings and pass time while he or she awaits resolution of their complaint, or simply to let off some steam. In this example, the user is prompted to destroy the electronic image of a car with an electronic baseball bat.

Turning now to FIG. 20, a CRM module presents to a user, at the user's request, a game intended to allow the user to release negative feelings and pass time while he or she awaits resolution of their complaint, or simply to let off some steam. In this example, the user is prompted to destroy the logo or other trademark of a business or individual with an electronic baseball bat.

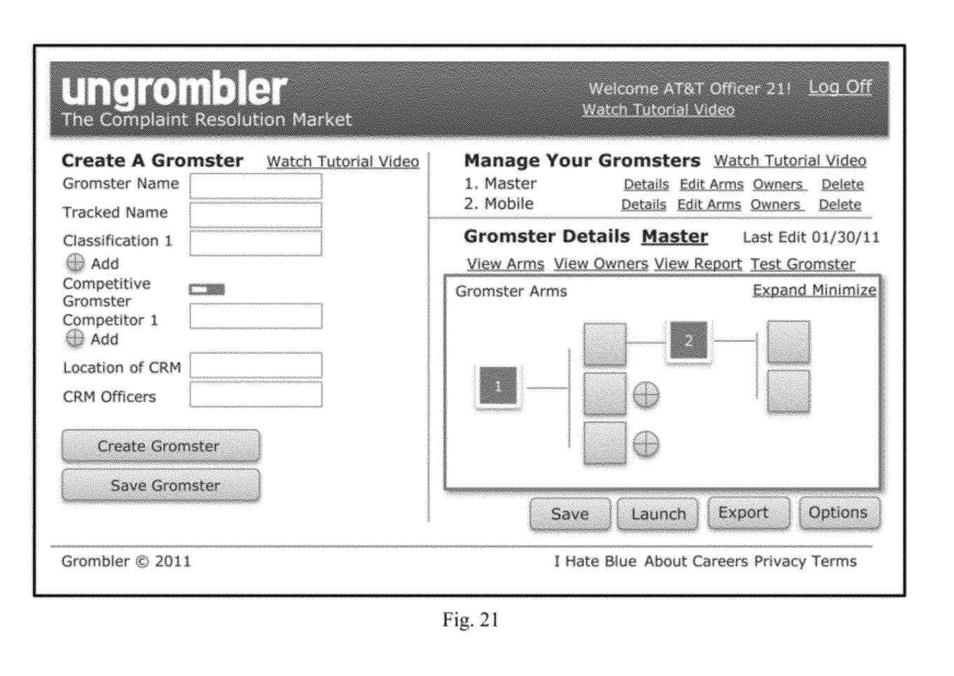

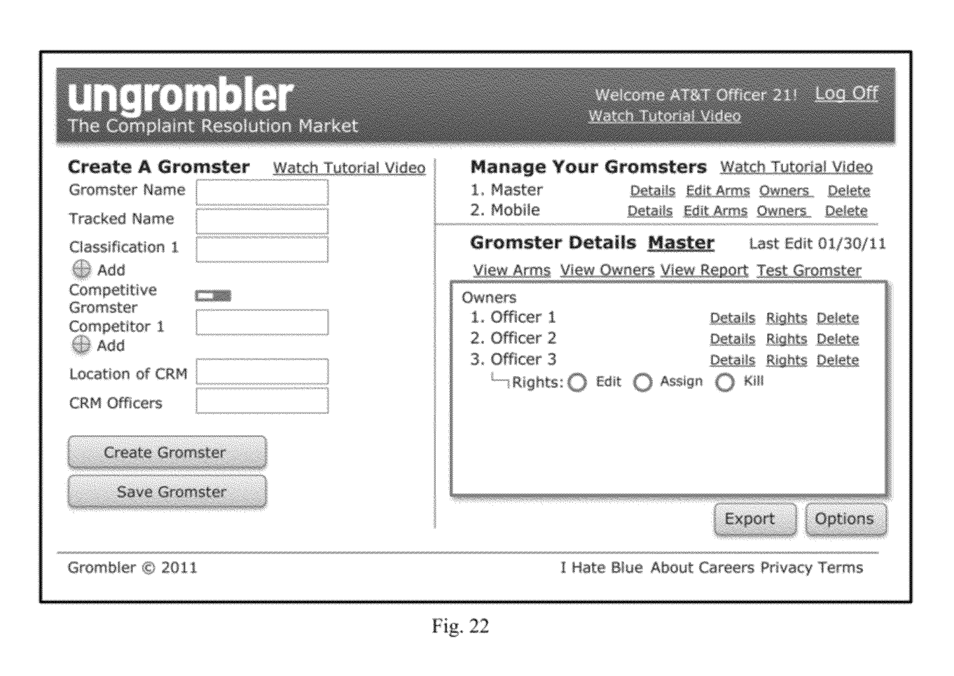

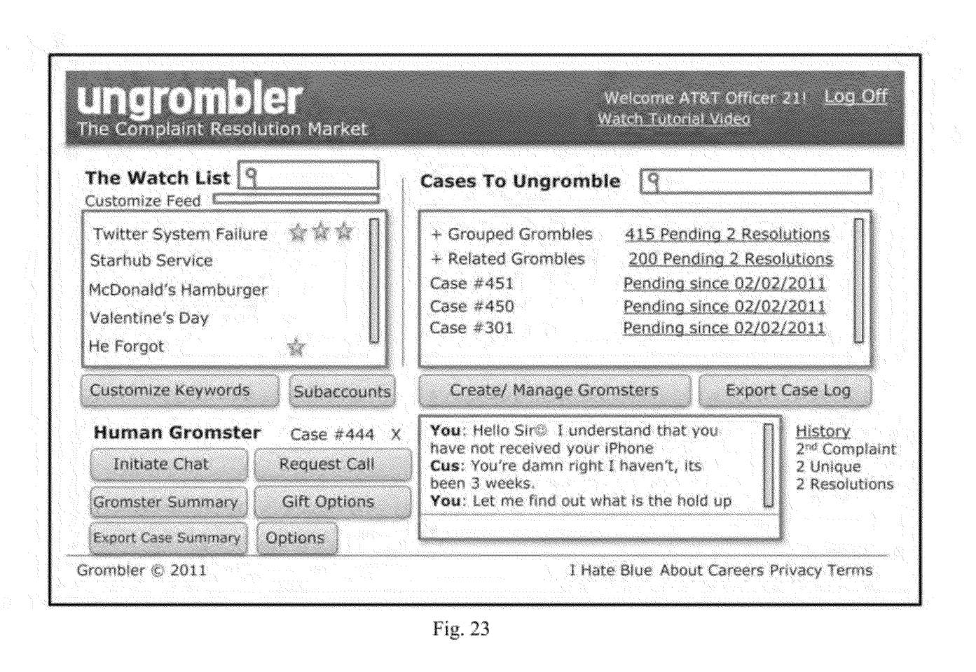

Turning now to FIGS. 21-23, an exemplary CRM module, as it would appear to a business or individual, in accordance with an embodiment of the present invention, is shown. FIG. 21 shows an exemplary configuration user interface in accordance with an embodiment of the present invention, including a section for configuring the list of automated dispute resolution questions and responses. FIG. 22 shows an exemplary configuration user interface in accordance with an embodiment of the present invention, including a section for selecting the various users assigned to manage or otherwise interact with the CRM module. FIG. 23 shows an exemplary dashboard for a CRM module, in accordance with an embodiment of the present invention, as it would appear during a manual or semi-manual dispute resolution process.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A method for providing an automated dispute resolution process, said method comprising:
receiving data at a CRM module,
wherein said data is for use with identifying customer complaints regarding an interest of an entity;
processing, at said CRM module, a search methodology base at least in part on said data;
identifying, with said CRM module utilizing said search methodology, one or more customer complaints regarding said interest of said entity;
initiating contact, via said CRM module, with one or more customers associated with said one or more customer complaints;
providing resolution, in conjunction with said CRM module, to one or more resolvable complaints,
wherein said one or more resolvable complaints are comprised of a subset of said one or more customer complaints.

2. The method of claim 1, wherein said interest of said entity includes one or more products or service related to a competitor of said entity.

3. The method of claim 1, wherein said resolution is provided by a competitor of said entity.

4. The method of claim 1, wherein said resolution is comprised of providing customer support to one or more of said customers associated with said one or more customer complaints.

5. The method of claim 1, wherein said resolution is comprised of providing a monetary settlement to one or more of said customers associated with said one or more customer complaints.

6. The method of claim 1, wherein said resolution is comprised of providing a coupon to one or more of said customers associated with said one or more customer complaints.

7. The method of claim 1, wherein said resolution varies based in part on a nature of said one or more customer complaints.

8. The method of claim 1, wherein said resolution varies based in part on a severity of said one or more customer complaints.

9. The method of claim 1, wherein each reputation of said plurality of reputations corresponds to a unique entity.

10. The method of claim 1, wherein said resolution is provided to a plurality of customers associated with said one or more customer complaints.

11. The method of claim 8, wherein said resolution is provided equally to said plurality of customers such that each customer of said plurality of customers receives the same resolution.

12. A system for providing an automated dispute resolution process, the system comprising:
a configuration module,
wherein said configuration module is capable of receiving and processing one or more parameters from one or more users,
wherein said configuration module is capable of processing said parameters into a plurality of data points;
an automated search module,
wherein said automated search module is capable receiving said plurality of data points from said configuration module,
wherein said automated search module is capable of using said plurality of data points to identify one or more complaints;
a dispute resolution module,
wherein said dispute resolution module is capable of receiving said one or more complaints from said automated search module,
wherein said dispute resolution module is capable of initiating a dispute resolution process with a customer related to said one or more complaints,
wherein said dispute resolution module is capable of processing a dialog with said customer,
wherein said dispute resolution module is capable of offering a resolution to said customer; and
a communications module,
wherein said communications module provides one or more communication pathways to allow communication with the system,
wherein said configuration module, automated search module and dispute resolution module and communications module are communicatively connected.

13. The system of claim 12, wherein said CRM module can be ranked and compete along side one or more other CRM modules.

14. The system of claim 12, wherein said system is further comprised of:
a customer complaint module,
wherein said customer complaint module is capable of receiving communications from one or more customers regarding a complaint.

15. The system of claim 12, wherein said parameters include search parameters.

16. The system of claim 12, wherein said parameters include dispute resolution parameters.

17. The system of claim 12, wherein said parameters include one or more dialogs.

18. The system of claim 12, wherein said configuration module is capable of generating parameters based at least in part on historical data and analysis.

19. The system of claim 12 wherein said automated search module is capable of recording historical data and analyzing said historical data.

20. The system of claim 12 wherein said dispute resolution module is capable of recording historical data and analyzing said historical data.
